(19) United States
(12) Patent Application Publication
(10) Pub. No.: US 2007/0097825 A1
(43) Pub. Date: May 3, 2007

(54) Waveform reconstructor for optical disk read channel

(75) Inventor: Keith R. Holstine, Colorado Springs, CO (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Plasmon LMS, Inc., Colorado Springs, CO (US)

(21) Appl. No.: 11/263,411

(22) Filed: Oct. 31, 2005

(51) Int. Cl. G11B 27/36; G11B 20/10

(52) U.S. Cl. 369/53.34; 369/47.28

(57) ABSTRACT

A waveform reconstructor is utilized in the read channel of an optical storage system in order to produce a high speed and reliable data output. Generally speaking, the waveform reconstructor provides readout signals from the optical storage media without utilizing a phase locked loop. In order to accomplish this, readout signals are first converted to digital signals, then provided to a digital equalizer for further signal conditioning. This equalizer use provides several advantages not available when PLL designs are utilized. Readout samples are then processed to determine a phase error, as compared with an ideally sampled signal. Once determined, this phase error allows for the reconstruction of the waveform, to create an output which is consistent with one which would have been sampled at precisely the correct time. The waveform reconstructor manages the calculated samples to determine whether actual asynchronous sampling is inconsistent with the anticipated samples. In order to make adjustments, where necessary, samples may be adjusted, inserted and/or skipped in order to accommodate for the calculated phase error. Following this processing, a reconstructed signal is then provided to a channel bit decoder for appropriate decoding of the bit stream.

### BACKGROUND OF THE INVENTION

The present invention relates to readout systems utilized in data storage devices. More specifically, the present invention provides high speed readout for an optical disk drive system which does not require the use of read signal phase locked loops.

Data storage systems are an integral part of today's society, storing massive amounts of information related to many different topics. Generally speaking, these data storage systems all include a storage media of some type, and related electronics to coordinate the storage and retrieval of information. Various types of storage media exist, which can be separated into two primary categories—magnetic and optical. Further, storage systems often include both removable and permanent media, each having particular advantages and disadvantages.

As known by those skilled in the art, several different components of the data storage system are required in order to coordinate the reading and writing of information. As an example, various synchronization systems are required to synchronize the flow of data with the movement of media and related components. Specifically, the rotation rate of the storage media must first be controlled and synchronized with other systems in the data storage device. Further, all systems must coordinate a consistent data format (i.e., physical layout) so that meaningful information is reproduced. Additionally, in optical storage devices the laser systems and related readout systems must also be carefully coordinated. Data storage systems also often include error correcting capability, which obviously requires additional coordination.

In addition to all the above-referenced operational concerns, data storage systems, generally speaking, are continuing to grow in size, speed and capacity. This is simply consistent with the demands for data storage capabilities and data processing capabilities. Today's storage systems are measured in gigabytes and are growing continually larger. Naturally, with capacities on this order, several operating characteristics are changing. For example, with data capacities at increased levels, the storage density of particular media is required to increase. With optical drives, increased density requires smaller spot and mark sizes, which thus requires increased precision in all related systems. Further, to deal with this increased capacity, comes increased demand for speed. Many factors effect overall speed, but a high rate of data through-put is required so that large amounts of data can be moved into and out of the data storage system.

Naturally, the readout systems which retrieve data from the media, along with all internal operating systems, must operate at faster speeds and higher capacities to meet the demands of related systems. Again, with these speed concerns in mind, a high rate of data through-put is particularly dependent upon the operation of the readout. More specifically, the readout system must be able to transfer data at sufficient rates to meet the desired data through-put rate.

Traditionally, readout systems within a storage system incorporate some kind of sampling loop including a PLL (phase locked loop). However, the delays incorporated in the PLL can detrimentally affect the bandwidth or stability of the readout system. That is, delays of traditional phase lock loops have limited the bandwidth, thus limiting the overall through-put from the data storage system. In addition, these systems typically require additional data overhead (longer VFO field) to allow for the PLL to become locked. Thus, it is desirable to minimize or eliminate the delays, in order to provide the desired bandwidth. Additionally, phase errors are often created by phase lock loops which also must be dealt with. Optical effects also have many detrimental results which can distort the signals causing detrimental effects to the system. Typical corrective efforts to deal with these optical effects (e.g., equalizers and related conditioning circuitry) can also create delays in the PLL based readout system. Again, for all these reasons, it is desirable to minimize delays in systems using phase locked loops.

In addition to the specific issues related to phase locked loops mentioned above, it is generally very desirable to create a read channel design which has a high bandwidth. Such design would generate a high through-put/data rate and provide the necessary speed for operation. Further, it would be beneficial to eliminate or avoid the above-referenced short comings in existing readout systems.

### BRIEF SUMMARY OF THE INVENTION

The present invention provides a readout system which creates a synchronous read signal from quasi-synchronous sample data. By utilizing this methodology, PLLs can effectively be eliminated from the readout system, thus eliminating the problems associated with increasing signal processing delays and helping to increase the bandwidth.

Generally speaking, the readout system of the present invention reconstructs the waveform to provide a sample that is equivalent to one which would have been sampled at precisely the right time. This avoids delays in timing issues inherent in existing readout systems, and again increases bandwidth. Further, the system of the present invention allows for the use of additional systems that provide conditioning and/or corrections desired. For example, the present invention can utilize an equalizer and other signal conditioning components to provide additional accuracy. This use of an equalizer provides compensation for many different things, such as defocus, disk tilts, cover layer deficiencies, and other undesirable optical effects.

As part of the waveform reconstruction, an accurate determination of the phase errors is required for effective operation. Following the determination of the phase errors, appropriate adjustments can then be made to achieve the reconstructed sample. More specifically, mathematical processing is used to determine appropriate signal sample values. Lastly, based upon the phase error and mathematical processing, the system is capable of skipping samples or inserting samples to appropriately adjust for bit slip (as described below, a condition where the magnitude of the phase error becomes to large to allow for simple adjustments to be made).

Generally speaking, the readout system includes an A-D converter which receives the readout signal and provides a converted digital signal to a digital equalizer. The digital equalizer is used for signal conditioning and other well known functions. Connected to the output of the digital equalizer is a specialized phase detector, which is utilized for analyzing the conditioned signal and determining the phase error value. The system then includes a waveform reconstructor component, which is utilized to reconstruct the readout signals. The waveform reconstructor and the specialized phase detector cooperate with a number of FIFO registers to accommodate bit slip of the quasi-synchronous data. Lastly, a read offset control is utilized to center the waveform before the channel bit decoder processes it. The read offset control is the only feedback loop utilized in the system.

In operation, the ADC receives the readout signal and converts it to a digital signal in a typical manner. As also typical with many readout systems, the ADC is synchronized with a signal from the media. In preferred embodiments, this signal is a wobble clock signal that is derived from a wobble structure on the media itself.

The output from the ADC is fed to a digital equalizer to provide magnitude and phase adjustments for optimal data decoding. Generally speaking, the equalizing functions are well known by those skilled in the art, and provide several advantages for optical read systems. The various coefficients for use by the equalizer are provided by feedback coming from the readout sections.

The output from the equalizer is provided to a specialized phase detector which calculates a phase error based on an anticipated signal characteristic. In addition, the specialized phase detector also calculates an estimated phase error at each midpoint, which is one half of the system channel bit. In order to achieve both calculations (phase error and midpoint phase error), first and second derivatives are utilized in the analysis to provide further accuracy. The use of these more comprehensive signal processing components allows for a more accurate phase error measurement and subsequent recreation of the waveform.

Within the specialized phase detector, the phase error calculations and read signal sampling are both utilized to set up a phase window centered at a zero point and extending one half sample period in both the positive and negative directions. Thus, the phase window of +/−0.5 T allows for two samples within the window (i.e., the actual read sample and a computed midpoint sample). By further analyzing these two samples, determination is then made as to which sample is closer zero. The “better” of these phase error calculations is then selected and output as the utilized phase error. Stated alternatively, this analysis allows for a determination of the most desirable sample of these two calculated phase error values. Thus, the read sample phase error or midpoint phase error, whichever is closest to zero, can then be utilized for further operations. This selected phase error is then output to the waveform reconstructor and to a register pointer/control device, which coordinates corrections to accommodate bit slip.

As mentioned above, the present invention reconstructs the waveform as if it had been sampled at precisely the right time. In doing so, the system recognizes that phase errors will create issues that must be accounted for. If the phase errors get too large, bit slip can occur wherein the reconstructed sample is determined to be at a position where either the next sample or the previous sample should be utilized. In order to accommodate this, the present invention includes a register pointer/control mechanism, along with a number of FIFO registers to manage and account for any bit slips. More specifically, the register pointer and control maintains a pointer to signal that sample insertions or deletions should be made. Generally speaking, this controls the timing aspect of the reconstruction activities. While the phase errors are within controlled levels, the pointer stays at a constant level and no adjustments are made. However, when the phase error gets sufficiently large in magnitude (either positive or negative slips), a shift is effectively instituted, causing either a sample deletion or sample insertion.

As mentioned, the present invention further includes a waveform reconstructor which receives both readout samples from the equalizer, and phase error signals from the specialized phase detector. The waveform reconstructor then calculates a reconstructed sample value based on these inputs. By accomplishing this reconstruction in this way, the waveform reconstructor can adjust for phase errors in its calculation. Additionally, the waveform reconstructor calculates an insert sample. This insert sample is of a value that would be appropriate if insertion is required. Both the reconstructed sample and the insertion sample are provided to a reconstruction register and an insert register respectively. These registers also receive control signals from the register pointer/control system of the present invention. Additional registers included in the system are utilized to track synchronization of equalizer and insert operations. All of these registers are identical and controlled by the same register pointer and control system.

At an output stage of the present invention, a multiplexer is utilized to receive both the reconstructed and the insert sample. Based upon a control signal from the register pointer/control mechanism, either the appropriate reconstructed sample or insert sample is output to a channel bit decoder. The output is also provided to a read offset control for use in monitoring read offsets. Naturally, the channel bit decoder provides an output to subsequent systems which provides for effective decoding of the marks and spaces saved on the disk.

As mentioned above, the read offset control also receives the reconstructed waveform samples from the multiplexer. The read offset control calculates offset errors and outputs appropriate adjustment signals, as is well know by those skilled in the art.

Lastly, a target pattern generator is utilized to provide a final check on the system operation. The target pattern generator receives the channel bit decoder output, and feeds back a signal which is combined with a delayed version of the reconstructed waveform to produce an error signal for the adaptive equalizer. The adaptive equalizer error signal controls the adjustment of the equalizer coefficient values.

As evident from the discussion above, the present invention is configured and designed to specifically provide a read channel with high bandwidth capable of accommodating data rates required by today's systems. Further, the system is set up and specifically designed to provide a synchronous read signal from a quasi-synchronous data sample. This feature allows for the elimination of a classic phase lock loop, thus avoiding the undesirable characteristics of those systems.

### BRIEF DESCRIPTION OF THE DRAWINGS

Further objects and advantages of the present invention can be seen from the following detailed description, in conjunction with the drawings, in which:

FIG. 1 is an overview of an exemplary data storage system utilizing the readout system of the present invention;

FIG. 2 is a block diagram of the waveform reconstructor system of the present invention;

FIG. 3 is a more detailed description of the digital equalizer utilized in the waveform reconstructor system;

FIG. 4 is a more detailed description of the phase detector utilized within the waveform reconstructor system;

FIG. 5 is a sample waveform diagram illustrating the phase detection methodology of the present invention;

FIG. 6 is a block diagram of the waveform reconstruction calculator;

FIG. 7 is a block diagram of the register pointer/controller; and

FIG. 8 is a block diagram illustrating the read offset control components.

### DETAILED DESCRIPTION OF THE INVENTION

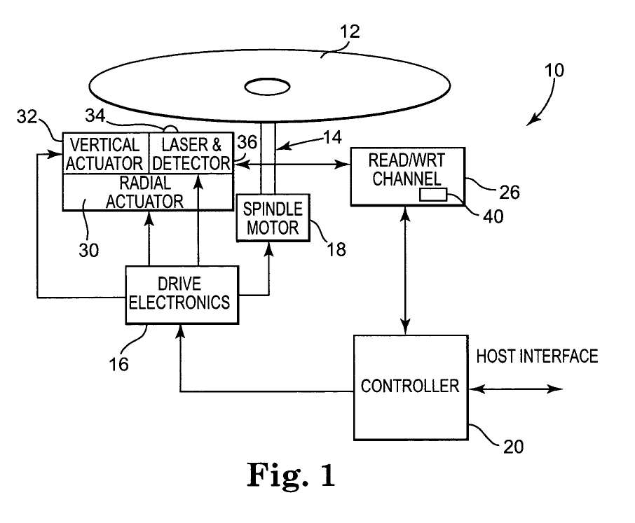

The present invention relates to a readout system used within a data storage device. While the data storage device can take many forms, one exemplary system is shown in FIG. 1. More specifically, the data storage device 10 utilizes a storage media 12 which, as mentioned, is an optical storage device. The use of optical storage media 12 has become well known and widely used in the industry because of its data storage capabilities and ease of access. In the present invention, the data storage media 12 is preferably removable, however could also be fixed within storage system 10. Storage media 12 is operably attached via a drive shaft 14 to a spindle motor 18. The drive shaft 14 is driven by spindle motor 18 which is controlled by drive electronics 16. Cooperating with drive electronics 16 are a laser assembly 36 including the laser itself (not shown), optics (not shown), and detection circuitry (not shown). Attached to laser assembly 36 are a radial actuator 30 and a vertical actuator 32 to provide appropriate movement and positioning. A lens 34 focuses a laser beam toward the desired region on media 12.

Laser assembly 36 is also connected to a read/write channel 26 for transferring the appropriate signals to and from the media 12. Similarly, read/write channel 26 is attached to controller 20 which coordinates the overall operation of storage device 10. Laser assembly 36 includes a typical split detector (not shown) used for tracking on media 12. As further outlined below, this split detector provides signals indicative of the structures present on the surface of media 12, including addressing information signals, data signals, and synchronization signals.

As illustrated in FIG. 1 and briefly discussed above, read/write channel 26 is utilized to receive output signals from the detector and thus provide appropriate signals to external devices. Within read/write channel 26 is the waveform reconstructor 40 of the present invention. Again, waveform reconstructor 40 is utilized to receive raw samples from the laser assembly 36 and perform appropriate processing.

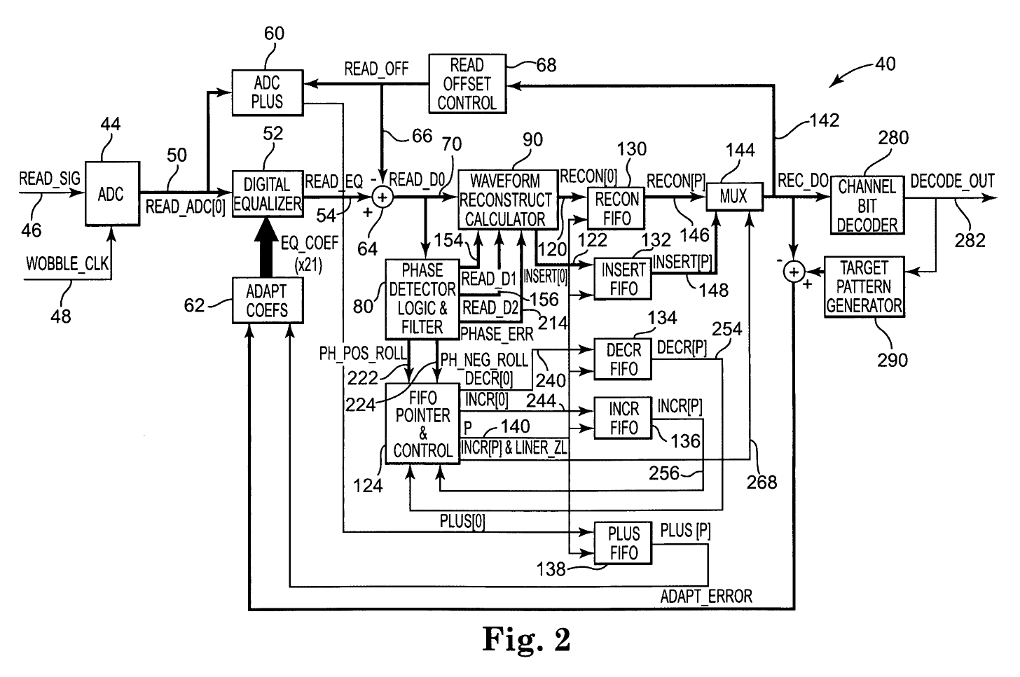

Referring now to FIG. 2, there is a general block diagram illustrating one embodiment of waveform reconstructor 40. As seen, the initial signals received by an analog to digital converter 44 (ADC) include the raw or analog read signal 46 (read_sig) and a wobble clock signal 48 (wobble_clk).

In optical disk recording, a quasi-synchronous sampling is typically generated using a wobble PLL (not shown) that is locked to a wobbled groove that is mastered on the disk. The wobble PLL generates wobble clock signal 48 which is a higher multiple of the frequency of the wobbled groove. Wobble clock signal 48 is frequency locked to the channel bit rate of the recorded data, and is used as the time base for sampling analog read signal 46. Analog read signal 46 is converted to a digital sample value using ADC 44. In this embodiment, ADC output 50 (read_adc[0]) is assumed to be a signed 8-bit value with the zero level at the center of the analog input range. ADC output 50 is a quasi-synchronous signal as a result of its being frequency locked to wobble clock signal 48.

The ADC output 50 is then provided to an adaptive digital equalizer 52 to produce an equalized read signal 54 (read_eq). Digital equalizer 52 is a multi-tap transversal FIR filter (21-tap for the example) employing Sign-Data Least Mean Squares (LMS) coefficient adaptation. Adaptive Digital Equalizer 52 is implemented using inputs from ADC Plus 60, the Target Pattern Generator 290 and Adaptive Coefficients Components 62, as shown in FIG. 2 and further discussed below.

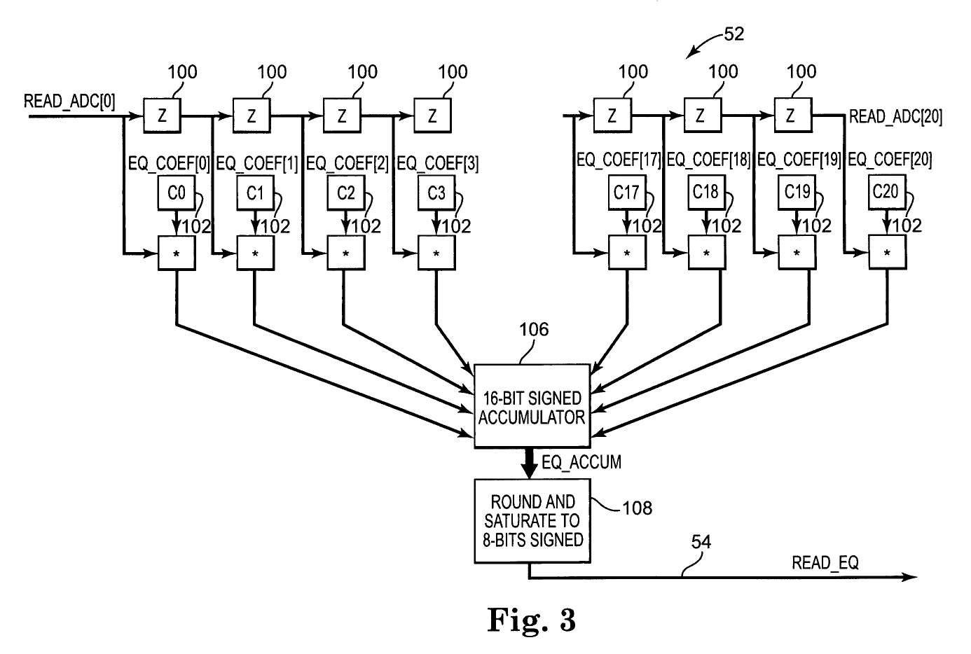

Referring now to FIG. 3, a block diagram of digital equalizer 52 is shown. As mentioned above, the block diagram shown implements a 21 tap transversal FIR filter. As is well understood, this implementation utilizes a plurality of delays 100, along with a plurality of coefficient registers 102, each configured to apply an appropriate coefficient to the appropriately timed signal and output that value to an accumulator 106. Using a final processing device 108, the values are rounded and saturated to provide an 8 bit signed output which is the equalized read signal 54.

Referring again to FIG. 2, further processing of equalized read signal 54 is shown. After equalization, a summing block 64 is utilized to subtract a digital read offset value 66 from the equalized read signal 54 and produce and offset controlled read signal 70 (read_d0). A Read Offset Control block 68 calculates the offset value 66 (read_off), and functions to center offset controlled read signal 70 near zero.

A specialized phase detector 80 receives the offset controlled read signal 70, and generally speaking, is utilized to determine the phase difference between the quasi-synchronous samples, and an ideally sampled data point. This phase error is calculated and normalized to range of −0.5 T to +0.5 T, where T is the channel bit period of the sampled read signal 46.

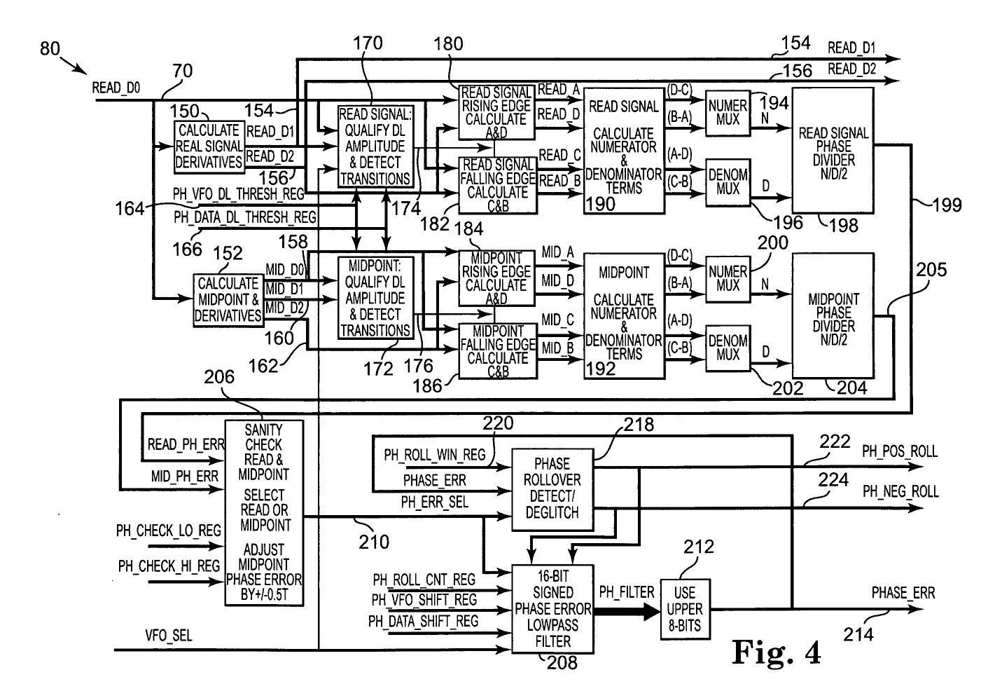

Referring to FIG. 4, a more detailed block diagram of specialized phase detector 80 is shown. As illustrated, the offset controlled read signal 70 is received by phase detector 80 and provided to a derivative calculation block 150 and a midpoints calculation block 152.

Specialized phase detector 80 begins its processing by generating several signals that are all derived from offset controlled read signal 70 (read_d0). More specifically, these signals are:
Read signal first derivative 154 (read_d1):
   read_d1ₙ=read_d0ₙ−read_d0ₙ₋₁
Read signal second derivative 156 (read_d2):
   read_d2ₙ=read_d1ₙ−read_d1ₙ₋₁.

A midpoint signal 158 (mid_d0) is also computed from the offset controlled read signal 70 (read_d0), along with related first derivative 160 (mid_d1) and second derivative 162 (mid_d2). These signals are calculated as follows:
Midpoint calculation 158 (mid_d0)
   mid_d0ₙ=(read_d0ₙ+read_d0ₙ₋₁)/2
Midpoint first derivative 160 (mid_d1):
   mid_d1ₙ=mid_d0ₙ−mid_d0ₙ₋₁
Midpoint second derivative 162 (mid_d2):
   mid_d2ₙ=mid_d1ₙ−mid_d1ₙ₋₁.

In order to achieve efficient operation, several practical considerations are made by waveform reconstructor 40. For example, “smaller” marks and spaces are not used. The resolution of 2 T and 3 T marks and spaces is very low. Due to the extremely high linear density of the recorded data with respect to the readout spot size, Therefore, specialized phase detector 80 of the present embodiment determines the phase error using only 4 T and longer marks and spaces. With this in mind, several measures are taken to ensure that there are not extended sequences of 2 T and 3 T marks and spaces:
1. 4 T-4 T mark and space patterns are inserted on regular intervals (Reference Fields)
2. Repeated 2 T-2 T patterns are limited in length by using a modified RLL(1,7) encoding scheme
3. All user data is “scrambled” before it is encoded to minimize fixed patterns in the channel bit data
4. A VFO Field (or preamble) is used at the start of each sector. The VFO Field consists of a repeated 4 T-4 T mark and space pattern for very fast phase error determination and correction.

Referring again to FIG. 4, it is shown that the read signal and midpoint values are processed simultaneously using two separate paths. The midpoint samples are used to correctly determine the phase error as it approaches ±0.5 T. Often, the read samples during a transition are near zero, but the midpoint samples for the same transition are clearly on opposite sides of zero. Using two paths greatly improves the phase detector robustness to noise on the read samples.

In both paths, the read signal first derivative signal 154 (read_d1) or midpoint first derivative signal 160 (mid_d1) is used to qualify the amplitude of the transitions. The amplitude required to qualify transitions is programmable by providing appropriate values for a VFO Field threshold 164 (ph_vfo_d1_thresh_reg) and Data Field threshold 166 (ph_data_d1_thresh_reg). These threshold values are utilized to perform an amplitude qualification in order to skip transitions caused by 2 T or 3 T marks and spaces. If the amplitude of the first derivative is sufficiently large and the signal crosses zero a transition is detected and the following values are computed:

In the Read Path:

```
if (|read_d1ₙ₋₁| > ph_data_d1_thresh_reg) and
(read_d0ₙ₋₁ > 0) and (read_d0ₙ₋₂ < 0)
{
    // Rising edge of read signal transition
    read_a = read_d0ₙ₋₁ − read_d2ₙ / 2
    read_d = read_d0ₙ₋₂ − read_d2ₙ₋₁ / 2
}
if (|read_d1ₙ₋₁| > ph_data_d1_thresh_reg) and
(read_d0ₙ₋₁ < 0) and (read_d0ₙ₋₂ > 0)
{
    // Falling edge of read signal transition
    read_c = read_d0ₙ₋₁ − read_d2ₙ / 2
    read_b = read_d0ₙ₋₂ − read_d2ₙ₋₁ / 2
}
```

In the Midpoint Path:

```
if (|mid_d1ₙ₋₁| > ph_data_d1_thresh_reg) and (mid_d0ₙ₋₁ > 0) and
(mid_d0ₙ₋₂ < 0)
{
    // Rising edge of midpoint signal transition
    mid_a = mid_d0ₙ₋₁ − mid_d2ₙ / 2
    mid_d = mid_d0ₙ₋₂ − mid_d2ₙ₋₁ / 2
}
if (|mid_d1ₙ₋₁| > ph_data_d1_thresh_reg) and (mid_d0ₙ₋₁ < 0) and
(mid_d0ₙ₋₂ > 0)
{
    // Falling edge of midpoint signal transition
    mid_c = mid_d0ₙ₋₁ − mid_d2ₙ / 2
    mid_b = mid_d0ₙ₋₂ − mid_d2ₙ₋₁ / 2
```

Referring again to FIG. 4, these various calculations are carried out by numerous components shown. Specifically, in the read signal channel, a qualification and detection block 170 is first utilized to detect the appropriate amplitude and transition. Similarly, a midpoint qualification and transition detect component 172 is also utilized to detect appropriate amplitude levels and transitions. Once the appropriate conditions are detected, output signals are produced at outputs 174 and 176 respectively to enable further calculations at that time. These signals, along with the previously measured and calculated signals are then provided to a number of calculation devices, to calculate various values. More specifically, a read signal rising edge calculation device 180, a read signal falling edge calculation device 182, a midpoint rising edge calculation device 184, and a midpoint falling edge calculation device 186 are all utilized to accomplish the calculations outlined above.

It is noted that the calculation outlined above utilize the second derivatives to determine these intermediate values. In this case, the second derivatives are incorporated to minimize the effects of inter-symbol interference caused by adjacent short marks and spaces. Utilizing these second derivative values, the resulting calculations above provide ISI compensated read samples and midpoints. (read_a, read_b, read_c, read_d and mid_a, mid_b, mid_c, mid_d, respectively). Utilizing these ISI compensated values, the calculated phase errors become much more accurate and avoid the detrimental effects of the proceeding or following short marks and spaces.

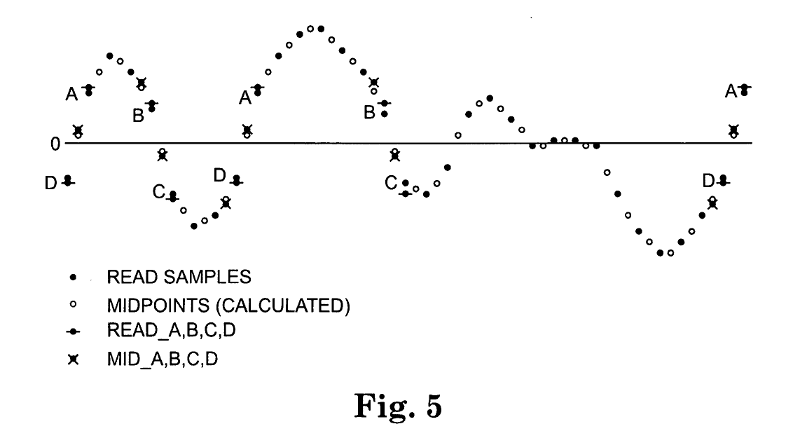

Utilizing these ISI compensated samples, phase detection is then completed utilizing the system outlined in FIG. 4. With reference to FIG. 5, there is shown one example read signal waveform with 4 T 4 T 7 T 3 T 3 T 2 T 2 T 6 T sequence of marks and spaces. FIG. 5 also shows the ISI compensated read samples and the ISI compensated midpoints as well.

Referring now more specifically to the read samples shown in FIG. 5, the read samples marked with A and D are associated with a rising edge transition that satisfies the above outlined conditions [(|read_d1ₙ₋₁|>ph_data_d1_thresh_reg) and (read_d0ₙ₋₁>0) and (read_d0ₙ₋₂<0).] That is, these samples identify rising edge transitions that have a first derivative of a sufficient magnitude. Sample A corresponds to read_d0ₙ₋₁ and sample D corresponds to read_d0ₙ₋₂. Likewise, the read samples marked with C and B are associated with a falling edge transition that satisfies the conditions [(|read_d1ₙ₋₁>ph_data_d1_thresh_reg) and (read_d0ₙ₋₁<0) and (read_d0ₙ₋₂>0).] Sample C corresponds to read_d0ₙ₋₁ and sample B corresponds to read_d0ₙ₋₂.

Whenever the read samples meet the qualifications for a valid transition (samples A, B, C, or D), the corresponding ISI compensated samples are computed. The ISI compensated samples are determined using the read sample and its second derivative. For example:
read_a=A−read_d2/2
read_b=B−read_d2/2
read_c=C−read_d2/2
read_d=D−read_d2/2

When short marks and spaces proceed or follow transitions from long marks and spaces, the transition changes slope near 0, which causes the magnitude of the second derivative to increase. This property of the read signal is used to adjust the values of read_a, b, c, d and thereby minimize the effect of ISI on the phase error calculation. The rough phase error without normalization is equal to the differences of the adjusted values (read_{—a}−read_b) and (read_d−read_c).

As further illustrated in FIG. 5, those regions having short mark and space pattern (3 T 2 T 2 T) do not include samples are marked with A, B, C, or D, and ISI compensated samples are not calculated. This is due to the fact that the transitions in this area are not large enough to meet the amplitude qualification criterion outlined above.

Using the above outlined ISI compensated read samples and midpoint values, the specialized phase detector 80 is then able to determine related phase errors. As mentioned above, the rough phase errors are easily calculated. However, it is important that the phase error be normalized, and yield a value between −0.5 T and +0.5 T. The normalized phase error value is computed for both the read and midpoints signals using the following equations:
Rising edge of read signal transition
   read_ph_err=(read_d−read_c)/(read_a−read_d)/2
Falling edge of read signal transition
   read_ph_err=(read_b−read_a)/(read_c−read_b)/2
Rising edge of midpoint signal transition
   mid_ph_err=(mid_d—mid_c)/(mid_a−mid_d)/2
Falling edge of midpoint signal transition
   mid_ph_err=(mid_b−mid_a)/(mid_c−mid_b)/2.

The above outlined calculations are carried out by various calculation systems within phase detector 80. A read signal numerator and denominator calculation block 190 outputs the possible values for both the numerator or denominator of the normalized read signal phase error calculation. These are then provided to a read signal numerator multiplexer (MUX) 194, a read signal denominator multiplexer (MUX) 196 which, under appropriate controls, provides their outputs to read signal phase divider 198. The output from read signal phase divider 198 provides a normalized read signal phase error 199 (read_ph_err) which is thus normalized to yield a value between −0.5 T and +0.5 T. Similarly, midpoint numerator and denominator calculation device 192 provides appropriate calculations to midpoint numerator multiplexer (MUX) 200 and midpoint denominator multiplexer (MUX) 202, which then provide signals to midpoint phase divider 204. The output from midpoint phase divider 204 then provides a normalized midpoint phase error 205 (mid_ph_err), which is again appropriately normalized.

Based on the calculations and analysis outlined above, the read signal phase error 199 determined from the read signal, and the midpoint phase error 205 determined from the calculated midpoints, should be approximately +/−0.5 T apart from one another. In order to provide a double check on the system, both the read signal phase error 199 and the midpoint error 205 are provided to a phase error analysis device 206 for further calculations and analysis. Initially, the relationship between the read signal phase error 199 and the midpoint phase error 205 is analyzed to verify that these two signals are approximately +/−0.5 T apart. This provides a “sanity check” to reduce or avoid the possibility of bad phase error updates due to noise or media defects. Following this check, it is desirable to determine which of the two phase errors are closest to zero. Stated alternatively, the system is looking for the phase error signal with the smallest absolute value. If the read signal of phase error 199 has the lowest absolute value, this value is then output as the selected phase error 210 (ph_err_sel) and passed to a low pass filter 208. Alternatively, if the absolute value of the midpoint phase error 205 is smaller, the system determines that this value should be utilized for further phase error analysis. However, when using the midpoint phase error 199, this phase error value must be corrected or adjusted by adding or subtracting 0.5 T to obtain the proper value. Looking to the actual value of the midpoint phase error 205 determines whether the adjustment should be in the positive or negative direction. More specifically, if the midpoint phase error is greater than zero, then 0.5 T should be subtracted from this value. However, if the midpoint phase error is less than zero, then 0.5 T should be added. Following this adjustment, the midpoint phase error 205 will then be utilized as the selected phase error signal 210 and passed on to the low pass filter 208. As shown in FIG. 4, the output from the low pass filter 208 is then provided to a shift register 212 which selects only the upper 8 bits and outputs this value as phase error value 214 (phase_err). Phase error value 214 is indicative of how the ADC sampling is operating. If phase error signal 214 is greater than zero, ADC 44 is sampling too late. Conversely, if phase error signal 214 is less than zero, ADC 44 is sampling too early.

Another feature of the present system is the ability to detect when “phase rollover” occurs. Phase rollover is defined as the point in time when the above-referenced phase calculations result in the phase error making a discontinuous step from −0.5 T to +0.5 T (positive phase rollover), or a discontinuous step from +0.5 T to −0.5 T (negative phase rollover). This rollover detection is analyzed in rollover detection device 218, which receives the selected phase error 210 and the phase error signal 214, along with an appropriate value from phase roll window register 220. All these signals are combined to detect positive or negative phase rollover, and output appropriate signals. More specifically, phase rollover detect device 218 will output a positive phase rollover signal 222 (ph_pos_roll) or a negative phase rollover signal 224 (ph_neg_roll) when those conditions are detected.

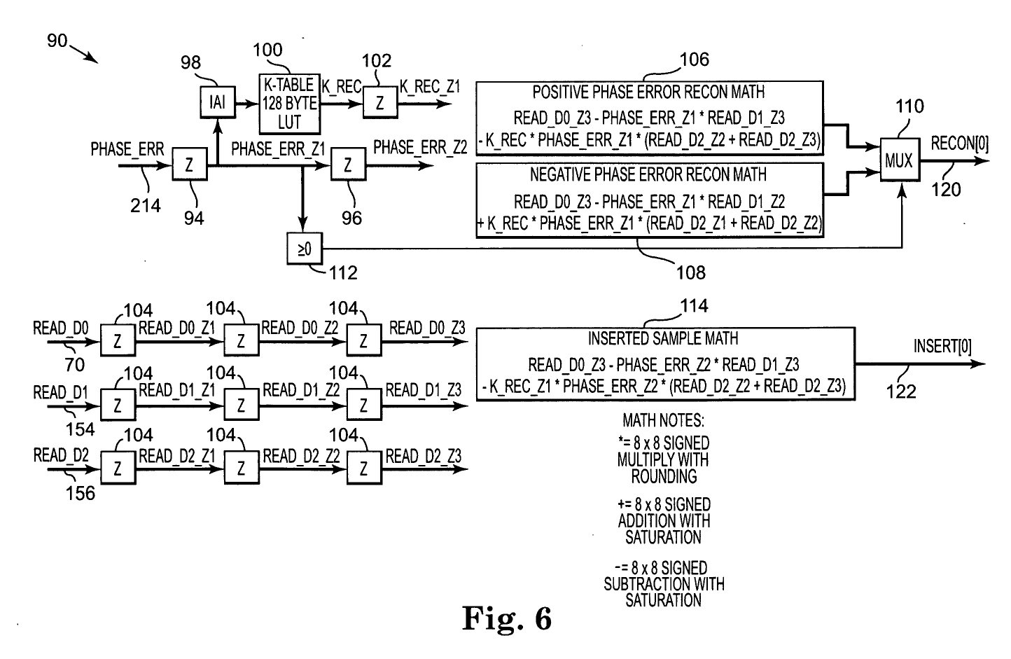

Now referring back to FIG. 2, it is shown that various signals generated by the specialized phase detector 80 are provided to a waveform reconstruction calculator 90. As previously mentioned, the offset controlled read signal 70 is provided to the waveform construction calculator 90. In addition, the read signal first derivative 154 and read signal second derivative 156 are likewise provided to waveform construction calculator 90, along with phase error 214. All of these signals are utilized by waveform reconstruction calculator 90 to compute the ideally sampled read signal values. More specifically, the ideally sampled read signal values are equivalent to those with a phase error equal to zero. Referring now to FIG. 6, a more detailed block diagram of waveform reconstruction calculator 90 is shown. Generally speaking, waveform reconstruction calculator 90 is utilized to implement the following equations to compute a reconstructed waveform value sample and an inserted sample value:

```
    if phase_errₙ₋₁ ≧ 0
        recon[0] = read_d0ₙ₋₃ − phase_errₙ₋₁ × read_d1ₙ₋₃ −
        k_recₙ × phase_errₙ₋₁ × (read_d2ₙ₋₂ + read_d2ₙ₋₃)
    else
        recon[0] = read_d0ₙ₋₃ − phase_errₙ₋₁ × read_d1ₙ₋₂ +
        k_recₙ × phase_errₙ₋₁ × (read_d2ₙ₋₁ + read_d2ₙ₋₂)
                                and
insert[0] = read_d0ₙ₋₃ − phase_errₙ₋₂ × read_d1ₙ₋₃ −
k_recₙ₋₁ × phase_errₙ₋₂ × (read_d2ₙ₋₂ + read_d2ₙ₋₃)
        where k_recₙ = {1 − |phase_errₙ₋₁|} / π.
```

As shown in FIG. 2, the values for a reconstructed sample 120 (recon[0]) and an inserted sample 122 (insert[0]) are output from waveform reconstruction calculator 90 and provided to two independent FIFOs in order to manage bit slip during waveform reconstruction. More discussion regarding the management of bit slip is provided below.

Now referring specifically to FIG. 6, more detail regarding waveform reconstruction calculator 90 is shown. As mentioned above, phase error signal 214 is first provided to a system which adjusts for the second derivative terms. More specifically, this system includes a first delay 94 and a second delay 96 which are utilized to adjust timing. The output from first delay 94 is provided to a rectifier 98 for determining the absolute value of the delayed phase error signal which is then provided to a look-up table 100. Look-up table 100 is utilized for determining the value of k_rec without performing the floating point math in real time. The output from look-up table is then provided to a third delay 102, thus providing an appropriate multiplier value.

Similarly, the offset control read signal 70 the first derivative 154 and the second derivative 156 are all provided to a plurality of identical delays 104 to provide staged outputs at appropriate points in time. Utilizing these various outputs, and the related signals as shown in FIG. 6, a number of calculation devices can carry out the equations listed above. (While specific connections are not shown, it is understood that the various signals shown are available to subsequent calculation blocks.) More specifically, a positive phase error reconstructor 106 is utilized for calculating the reconstructed signal when the phase error is positive. Similarly, a negative phase error reconstructor device 108 calculates the reconstructed signal when the phase error is negative. Both of these reconstructors provide their outputs to a reconstructor multiplexer 110 which is controlled by a phase error control device 112 which provides an appropriate signal indicating whether the phase error is positive or negative. Similarly, an insert value calculation device 114 is provided to calculate an insert sample 122. As discussed above, the output from constructor multiplexer 110 provides a reconstructed signal 120, representing the ideally sampled read signal value, along with insert sample 122, for use by subsequent components.

As suggested above, bit slip is an issue for the reconstructor of the present invention, due to the quasi-synchronous nature of the ADC samples. Again, bit slip is defined as the condition where the quasi-synchronous sampling differs by more than plus or minus 0.5 T from a synchronous sampling point. When this occurs, the waveform reconstruction process of the present invention must make appropriate adjustments to accommodate for this slip. Generally speaking, the waveform reconstruction process of the present invention adjusts to utilize a new sample that is within the +/−0.5 T range. This function is accomplished by the various registers or FIFO's shown in FIG. 2. More specifically, FIG. 2 includes a reconstruction sample FIFO 130, an insert sample FIFO 132, a decrement FIFO 134 and increment FIFO 136, and a plus FIFO 138. Generally speaking, each of these registers or FIFOs is indexed by a single FIFO pointer P 140 which is generated by the FIFO pointer/control device 124. Data samples and bit flags that are loaded into the FIFOs will be output P cycles later. By coordinating these various registers, and having them all be controlled by the same FIFO pointer P 140, the timing and coordination of waveform constructor 40 is accomplished.

Referring more specifically to the various registers, reconstruction sample FIFO 130 generally contains the reconstructed waveform sample. Insert sample FIFO 132 contains samples to be inserted in the event of a negative phase rollover condition. Decrement FIFO 134 contains a bit flag indicating that the FIFO pointer must be decremented by one, and increment FIFO 136 contains a bit flag indicating that FIFO pointer P 140 must be incremented by one.

Again, during the reading of samples, ADC 44 may be sampling at a faster rate than an ideal synchronous sample rate. This variation in sampling rate causes the above-referenced phase rollover (i.e., phase error magnitude increasing beyond +/−0.5 T, thus causing a discontinuous jump in the measured phase error signal 214). When the sampling rate is slightly faster than ideal, a positive phase rollover occurs, meaning the reconstructed waveform sample 120 must be skipped. Alternatively, when the ADC sampling rate is slightly slower than an ideal rate, a negative phase rollover occurs. During a negative phase rollover condition, an additional reconstructed waveform sample must be inserted (insert sample 122). As discussed above, insert samples 122 are calculated continuously, thus making this insertion fairly straight forward. In order to accomplish this in waveform reconstructor 40, skipping of a sample is accomplished by simply decrementing FIFO pointer 140. On the other hand, when it is necessary to insert a sample, the insert sample 122 is taken from insert FIFO 132, and the FIFO pointer 140 is incremented.

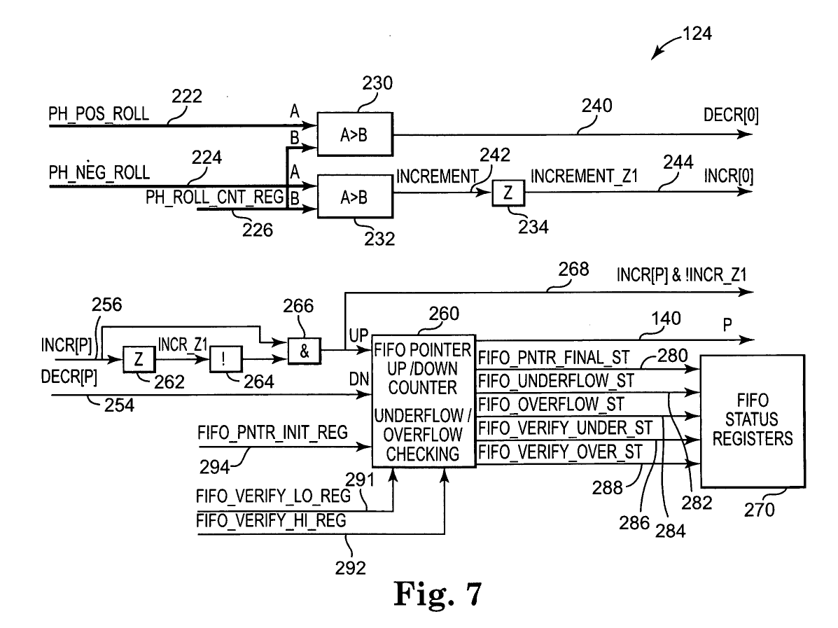

As mentioned, the various FIFOs discussed above are all controlled by FIFO pointer/control device 124. Further details regarding FIFO pointer/control 124 are shown in FIG. 7. As can be seen, FIFO pointer/control 124 receives both positive phase rollover signal 222 and negative phase rollover signal 224 in a first comparator 230 and a second comparator 232, respectively. Both the first comparator 230 and second comparator 232 are utilized to insure that the positive phase rollover signal 222 and negative phase rollover 224 are above a threshold level before taking further action. If the signals are above a threshold level, input by a phase roll control register signal 226 (ph_roll_cnt_reg), an appropriate output is provided. Specifically, if positive phase rollover signal 222 indicates that a positive phase rollover has occurred, that signal will necessarily be above the signal provided by phase roll control signal 226. This causes first comparator 230 output a decrement signal 240. Similarly, second comparator 232 is used to determine if a negative phase rollover has occurred by analyzing negative phase rollover signal 224. When this condition occurs, second comparator 232 will output an increment signal 242. Because an increment signal indicates that an insertion must be made, a timing delay must be incorporated to insure proper timing. Consequently, delay 234 receives increment signal 242 and subsequently outputs a timed increment signal 244.

Referring again to FIG. 2, it is seen that the timed increment signal 244 and decrement signal 240 are both provided to the appropriate FIFO register (i.e., decrement FIFO 134 and increment FIFO 136). Again, based upon FIFO pointer value 140, each of these registers will output the signals at a time period P cycles later. Specifically, decrement FIFO 134 will then provide a timed decrement output 254. Similarly, increment FIFO 136 will provide a timed increment output 256. Again, the timing of these outputs is controlled by the FIFO pointer 140.

Looking now to the generation of FIFO pointer 140 as illustrated in FIG. 7, this signal is largely generated from a FIFO pointer up/down counter 260 which receives the timed decrement signal 254 and the timed increment signal 256 (via delay). Bit flags were placed in the appropriate FIFOs when a positive or negative rollover was detected, as discussed above. FIFO pointer counts down by one on each occurrence of the time decrement signal 254. Similarly, the FIFO pointer counts up by one when the timed increment signal 256 is received. It is noteworthy that a lock out is provided to insure that an increment step cannot be accomplished on two consecutive steps. This is accomplished by using by utilizing delay 262 and inverter 264. These two signals are then provided to an AND logic gate 266 to produce the (incr[p] & !incr_z1) signal 268 which insures that the two consecutive increment steps cannot occur.

In addition, FIFO counter and control logic 260 also provides status information to a FIFO status register 270. This status information is generated by FIFO counter and control logic 260. The value of the FIFO pointer is saved at the end of each sector that is read and provided as a final pointer value 280 (fifo_pntr_final_st). FIFO underflow/overflow conditions are also detected. If the FIFO pointer is at 0 and receives a decr bit flag, FIFO Underflow status signal 282 (fifo_underflow st) is posted. Likewise, if the FIFO pointer is at its maximum value and receives an incr bit flag, FIFO Overflow status signal 284 (fifo_overflow_st) is posted. Both of status conditions indicate that uncompensated bit slip has occurred. Two additional status bits are generated that can be used for verifying recorded data. Both of these status bits are utilized to monitor operation as compared to programmable values. When the FIFO pointer is less than a programmable low value 291 (fifo_verify_lo_reg), the verified low status bit 286 is set (fifo_verify_under_st). When the FIFO pointer is greater than a programmable high value 292 (fifo_verify_hi_reg), the verified high status bit 288 is set (fifo_verify_over_st). Information from these two bits can be used to determine if sectors should be relocated due to disk defects that affect the Wobble PLL clock 48 and cause excessive bit slip within a sector.

At the start of reading each sector, FIFO pointer P 140 is initialized with a programmable value (fifo_pntr_init_reg) 294. The FIFO pointer/control logic 260 would typically be initialized to the center (half) of the FIFO length. For example, if a FIFO length of 32 is used, the FIFO pointer P 140 would be initialized to 16. This allows for bit slip in either direction (fast or slow). The FIFO length is determined by the maximum number of channel bits that are expected to slip during the read back of one sector. This will primarily be based on the timing jitter of the Wobble PLL clock 48.

As discussed in relation to FIG. 7 above, delay 262 and delay 264, along with logic gate 266 are utilized to provide the (incr[p] & lincr_z1) signal 268 causing FIFO pointer/control logic 260 to count up. The (incr[p] & lincr_z1) signal 268 is similarly utilized to control a multiplexer 144 shown in FIG. 2. As shown, multiplexer 144 receives the timed reconstructed sample 146 and the timed insert sample 148. When the pointer requires and increment or up count, the insert sample must be incorporated. This is accomplished by appropriately controlling multiplexer 144 to select the timed insert signal 148 and provide it as the reconstructed ouput 142 (rec_d0) to a channel bit decoder 280. Otherwise, the timed reconstruction signal 146 is provided from the output multiplexer 144 as reconstructor output 142 and passed to channel bit decoder 280.

Channel bit decoder 280 is a well understood mechanism that determines the sequence of marks and space lengths, as recorded on the storage media. Typically a Viterbi decoder is used for Partial Response Maximum Likelihood (PMRL) channel design. The decoder produces a bit stream 282 (decode out) that is used by an RLL (1, 7) data decoder (not shown).

Also shown in FIG. 2, the system utilizes a target pattern generator 290 which also receives the bit stream output 282 to create a target pattern waveform using the desired levels for the partial response (PR) scheme implemented in the Viterbi decoder. The difference between the target pattern waveform and the delayed reconstructed waveform is used as an error signal which is then fed back to adaptive equalizer 52. This target pattern generator scheme is generally well known and understood by those skilled in the art.

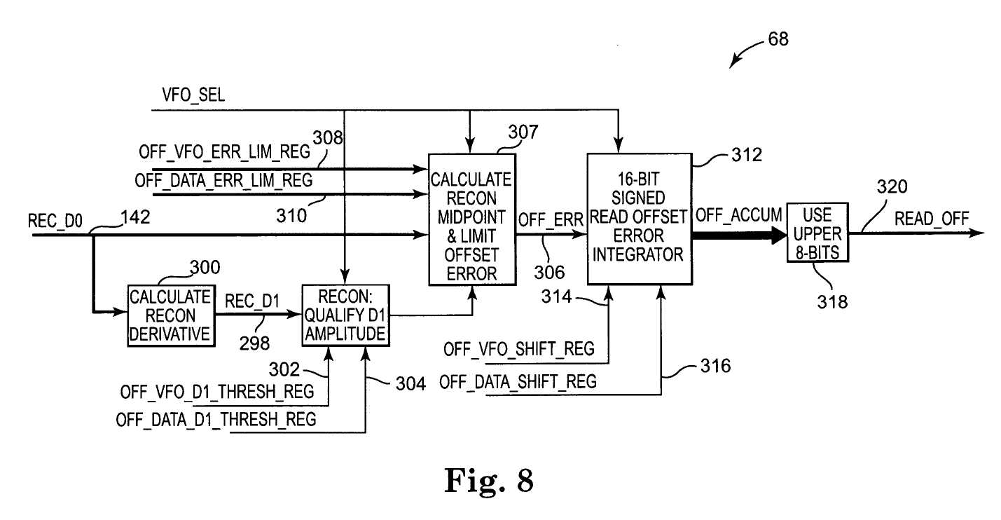

As mentioned above, waveform reconstructor 40 also includes a read offset control 68 which generates the read offset signal (read_off) 66 that is fed back to provide offset centering of the reconstructed waveform. Read offset control 68 is shown in more detail in FIG. 8. As seen, read offset control 68 utilizes the reconstructor output 142 and its derivative to determine read offset value.

The first derivative 298 of the reconstructed waveform 142 is calculated in derivative calculator 300 and is defined as follows:
rec_d1ₙ=rec_d0ₙ−rec_d0ₙ₋₁

Similar to the specialized phase detector 80, the first derivative signal 298 (rec_d1) is used to qualify the amplitude of transitions. The amplitude required to qualify transitions is programmable by an offset VFO threshold signal 302 (off_vfo_d1_thresh_reg) and an offset data threshold signal 304 (off_data_d1_thresh_reg) for the VFO Field and Data Field, respectively. The read offset error 306 (off_err) is computed by finding the center of the long mark and space transitions in the reconstructed waveform. The following equation is used:
if |rec_d1ₙ|>off_data_d1_thresh_reg
off_errₙ=(rec_d0ₙ+rec_d0ₙ₋₁)/2

The offset error can be limited in magnitude to minimize undesirable response caused by dust or media defects. The limit is programmable by a VFO error limit value 308 (off_vfo_err_lim_reg) and a data error limit value 310 (off_data_err_lim_reg) providing appropriate values for the VFO Field and Data Field, respectively.

The offset error 306 then feeds into a digital integrator 312. The gain of the integrator is programmable and controlled by a VFO gain value 314 (off_vfo_shift_reg) and a data gain value 316 (off_data_shift_reg) for the VFO Field and Data Field, respectively. The read offset integrator output 320 (read_off) is used as a feedback and subtracted from the equalized read signal 54 (read_eq) to actively control read signal offset variations, as mentioned previously.

Utilizing the system and components outlined above, the waveform reconstructor of the present invention accomplishes the output of read channel signals without the use of a PLL timing loop. Due to the lack of this timing loop, significant advantages are achieved, including higher bandwidth and very fast phase correction. Additionally, the use of a digital equalizer is possible since the output is not dependent upon a PLL.

The advantages and features of the present invention, along with other advantages, will be understood by those skilled in the art. While various embodiments of the present invention have been described above in order to illustrate their features and operation, it is not intended that the present application be limited to these embodiments. It is clearly understood that certain modifications and alterations can be made without departing from the scope and spirit of the following claims.

What is claimed is:

1. A waveform reconstructor for providing synchronous read samples from an optical readout system, the waveform reconstructor comprising:
an A/D converter for receiving a read signal from the optical readout system and producing a digital read signal;
a digital equalizer attached to the A/D converter for receiving the digital read signal and producing an equalized signal;
a phase detector receiving the equalized signal and determining a phase error between the equalized signal and an ideal signal, wherein the ideal signal represents a theoretical read signal which would have been sampled synchronously, the phase detector then producing a phase adjustment signal and a phase roll signal;
a waveform calculator receiving the equalized signal and the phase adjustment signal and utilizing those signals to produce a calculated waveform output and a calculated insert value;
a calculated waveform buffer for receiving the calculated waveform output;
a insert buffer attached to the waveform calculator to receive a calculated insert value;
an insert control for receiving the phase error signal and producing a phase control output indicative of phase adjustments that are required;
a multiplexer for receiving an output from the calculated waveform buffer, the insert waveform buffer and the insert control, the multiplexer for producing an output equal to an output from the calculated waveform buffer or the insert waveform buffer depending on the state of the insert control signal, the output from the multiplexer being substantially equal to the synchronous read sample.

2. The waveform reconstructor of claim 1 wherein the digital read signal is a quasi-synchronous signal coordinated with a signal from the surface of the media.

3. The waveform reconstructor of claim 1 wherein the equalizer is a multi-tap transversal FIR filter.

4. The waveform reconstructor of claim 1 wherein the phase error is determined by analyzing a sampled read waveform and a calculated midpoint.

5. The waveform reconstructor of claim 4 wherein a midpoint phase error and a read signal phase error are calculated by the phase detector and the phase error is determined to be equal to the midpoint phase error if the magnitude of the midpoint phase error is smaller than the magnitude of the read signal phase error, but the phase error is determined to be equal to the read signal phase error if the magnitude of the midpoint phase error is larger than the magnitude of the read signal phase error.

6. The waveform reconstructor of claim 1 wherein the insert sample is used when the determined phase error is greater than 0.5 T.

7. The waveform reconstructor of claim 5 wherein the insert sample is used when the determined phase error is greater than 0.5 T.

8. A method for generating a readout signal within a data storage system indicative of patterns stored on a storage media, comprising:
receiving a raw readout signal from an optical pickup within the data storage system and converting the raw readout signal to a plurality of digital readout samples;
adjusting the plurality of digital readout samples to account for an offset, thus creating a plurality of offset adjusted readout samples;
analyzing the plurality of offset adjusted readout samples to determine a calculated phase error;
calculating a plurality of reconstructed readout samples based upon the plurality of adjusted readout samples and the phase error, wherein the plurality of reconstructed readout samples account for the phase error by analyzing the plurality of adjusted readout samples to determine a value for each reconstructed sample which is equal to a calculated value adjusted so the phase error is eliminated; and
outputting the plurality of reconstructed readout samples for further analysis by the data storage system.

9. The method of claim 8 wherein the step of analyzing the plurality of adjusted readout samples to determine phase error further comprises:
analyzing the plurality of offset adjusted readout samples to determine a sampled phase error;
calculating of a plurality of midpoint samples, wherein each midpoint sample is calculated to be a theoretical sample existing between any two of the offset adjusted readout samples;
analyzing the plurality of midpoint samples to determine a midpoint phase error; and
selecting the calculated phase error to be the sampled phase error if the sampled phase error has a magnitude smaller than that of midpoint phase error, or selecting the calculated phase error to be the midpoint phase error if the midpoint phase error has a magnitude that is smaller than that of the sampled phase error.

10. The method of claim 9 wherein the sampled phase error and the midpoint phase error are determined by analyzing transitions in a waveform created by the plurality of offset adjusted readout samples and transitions in a waveform created by the plurality of midpoint samples, respectively.

11. The method of claim 9 wherein the sampled phase error and the midpoint phase error are adjusted to be within a predetermine phase window prior to the step of selecting by adding or subtracting an adjustment value.

12. The method of claim 11 wherein a bit slip identifier is created when adjustments are made, the bit slip identifier used to identify an adjustment condition.

13. The method of claim 12 further comprising calculating a plurality of insert samples based upon the plurality of adjusted readout samples and the phase error, wherein the plurality of insert samples account for the phase error when the phase error is above a predetermined value by analyzing the plurality of adjusted readout samples to determine a value for each insert sample which is equal to a calculated value adjusted so the phase error is eliminated.

14. The method of claim 13 wherein the insert sample is inserted into the plurality of reconstructed samples when the bit slip identifier indicates the adjustment condition has occurred.

15. The method of claim 14 wherein the offset adjustment is achieved by examining the plurality of reconstructed samples and any insert samples output for further analysis by the data storage system.

16. The method of claim 8 wherein the digital readout samples are produced at a channel bit rate.

17. The method of claim 16 wherein the production of reconstruction samples is achieved utilizing samples produced only at the channel bit rate.

18. A readout system for reading data from a data storage media within a data storage device, comprising:
an optical readout for providing a readout output signal indicative of the optical properties of the data storage media and a timing signal synchronized with the movement of the media;
an analog to digital converter operably attached to the optical readout for receiving the output signal and creating a plurality of digital samples based upon the readout output signal and the timing signal;
an equalizer attached to the analog to digital converter for receiving plurality of digital samples and performing signal conditioning operations to produce a plurality of equalized readout samples;
a phase detector for receiving the plurality of equalized readout samples and determining a phase error, wherein the phase detector determines the phase error by calculating both a sampled phase error and a midpoint phase error, the sample phase error determined by first determining a plurality of transitions in the plurality of equalized readout samples and analyzing these transitions, and the midpoint phase error is determined by calculating a plurality of midpoint values based upon the plurality of equalized readout samples, wherein each midpoint sample being between two of the equalized readout samples, the midpoint phase error further calculated by determining transitions in the plurality of midpoint samples and analyzing these transitions, the phase detector further adjusting the sampled phase error and the midpoint phase error when the magnitude of either exceeds a predetermined value and providing an adjustment signal to indicate that such adjustment has been made, and the phase detector phase further selecting between the sampled phase error and the midpoint phase error based upon a predetermined criteria to generate the phase error;
a waveform reconstructor operably connected to the equalizer and the phase detector, the waveform reconstructor receiving the plurality of equalized readout samples and the phase error and calculating a plurality of reconstruction samples and a plurality of insert samples, wherein the plurality of reconstruction samples are each of a value which accounts for the phase error when the phase error is below a predetermined value, and the plurality of insert samples are each of a value which accounts for the phase error when the phase error is above the predetermined value; and
an output and timing control operably attached to the waveform reconstructor and the phase detector, wherein the output and timing control directs the output of the plurality of reconstructed samples from the readout system when the magnitude of the phase error is below the predetermined value and the adjustment signal has not been received, wherein the output and timing control directs the insertion of one of the insert samples into the plurality of reconstructed samples when the adjustment signal has been received and the adjustment was made in a first direction, and wherein the output and timing control directs the elimination of one sample in the plurality of reconstructed samples when the adjustment signal has been received and the adjustment was made in a second direction.

19. The system of claim 18 wherein the output and timing control includes a controller, a reconditioned sample register to receive the plurality of reconditioned samples, an insert sample register to receive the plurality of insert samples, an increment register to receive an increment control signal, a decrement register to receive a decrement control signal, and a multiplexer, wherein the controller includes a pointer output to control the output from the registers and an output signal for controlling the output of the multiplexer, wherein the controller controls the output from the readout by maintaining a constant pointer value when the phase error is below the predetermined value thus causing the plurality of reconstructed sample to pass from the reconstructor, through the multiplexer and out of the output, wherein the controller causes the insertion of one of the insert samples into the plurality of reconstructed samples when the adjustment signal has been received and the adjustment was made in a first direction by outputting an increment control signal to the increment register which subsequently causes the pointer value to increment and the multiplexer to output the insert sample, and wherein the controller causes the elimination of one sample in the plurality of reconstructed samples when the adjustment signal has been received and the adjustment was made in a second direction by outputting a decrement control signal to the control register which subsequently causes the pointer to decrement.

20. The system of claim 18 further comprising a read offset controller which receives the output and determines if an offset is present and when the offset is present, outputs an offset adjustment signal which is also removed from the readout output signal to create the offset controlled read signal.

21. The system of claim 19 further comprising feedback from the output to the equalizer so as to dynamically adjust the operation of the equalizer.

22. The system of claim 20 wherein the equalizer is a multi-tap transversal FIR filter.

23. The system of claim 18 wherein the predetermined value is +/−0.5 T.

24. The system of claim 18 wherein the digital samples are created at a channel bit rate, with the channel bit rate being related to the timing signal.
